(19) United States
(12) Patent Application Publication
(10) Pub. No.: US 2010/0314886 A1
(43) Pub. Date: Dec. 16, 2010

(54) FUNNELED WIND TURBINE AIRCRAFT FEATURING A DIFFUSER

(76) Inventor: Lynn Potter, Barstow, CA (US)

Correspondence Address: LOZA & LOZA LLP, 305 North Second Ave., #127, Upland, CA, 91786-6064, US

(21) Appl. No.: 12/862,700

(22) Filed: Aug. 24, 2010

Related U.S. Application Data
(63) Continuation-in-part of application No. 12/124,573, filed on May 21, 2008, now Pat. No. 7,786,610.
(60) Provisional application No. 60/939,604, filed on May 22, 2007.

(51) Int. Cl. F03D 9/00; F01D 1/16; B64B 1/50

(52) U.S. Cl. 290/55; 415/81; 244/33

(57) ABSTRACT

An aircraft adapted to house a wind funnel, a wind diffuser, and a wind turbine configured to convert airflow flowing through the wind funnel into electricity is provided. The aircraft may feature a diffuser that increases the airflow through the wind funnel to increase power production. An electrical cable between the aircraft and a ground station transfers the generated electricity from the aircraft to the receiving ground station for distribution. In other embodiments, an aircraft featuring a plurality of buoyant bodies, wind funnels, diffusers, and turbines are coupled to a truss to form a module that generates electricity from airflow. In one embodiment, a plurality of modules may be interconnected to form a module array that is secured to a ground station responsible for receiving the electricity generated. Certain embodiments feature pitch control lines to control the pitch of the aircraft and modules facing the airflow.

### CLAIM OF PRIORITY

This is a non-provisional continuation in part patent application which claims priority to Non-provisional Patent Application No. 12/124,573 filed on May 21, 2008, and Provisional Patent Application No. 60/939,604 filed May 22, 2007, the entire disclosures of which are hereby expressly incorporated by reference herein.

### FIELD

The invention relates to the field of wind-based energy generation and, in particular, to a high-altitude blimp having a funneled wind turbine featuring a diffuser that improves electricity generation.

### BACKGROUND

In recent years, environmentally friendly and cost-efficient energy sources have been explored to reduce dependence on fossil-based fuels. One such alternative energy source is wind-based electric energy. However, many wind-based energy generating systems (e.g., wind mills, etc.) fail to be cost-efficient.

U.S. Pat. No. 7,129,596 describes a hovering wind turbine in which structures with turbine blades are supported in the air by a plurality of blimps. This design fails to harness or concentrate wind power to efficiently generate electricity.

U.S. Pat. No. 4,166,596 describes a tethered wind generating aircraft in which fan blades turn pulleys coupled to a large “fan belt” that runs to a generator on the ground. This design is cumbersome in that the “fan belt” is run from the aircraft to ground. Consequently, such system may be difficult to implement in high-altitude applications.

Additionally, many prior art wind turbines devices are not optimized to take advantage of high-altitude wind currents which tend to be steadier and more powerful than low-altitude wind currents.

### SUMMARY OF INVENTION

A wind-to-power generator aircraft comprising: a primary body filled with a lighter-than-air gas to provide buoyancy to the aircraft; a wind funnel coupled along a length of the primary body, a large end of the wind funnel located at a front of the aircraft and a small end of the wind funnel located approximately at a middle of the aircraft, the wind funnel positioned to concentrate airflow from the large end to the small end; a wind-to-electricity turbine coupled at the small end of the wind funnel wherein the turbine is ducted; and a tether coupled to the aircraft at a point near the turbine to secure the aircraft to the ground and transmit electricity from the turbine to a ground station is provided.

In some embodiments, the turbine may be adapted to convert the airflow into electricity. The aircraft of claim may further include a rudder coupled to the rear of the aircraft. The wind funnel of the aircraft may be coupled along a bottom portion of the primary body. The primary body may be made from a light weight material. The aircraft may further include a winch configured to adjust the altitude of the aircraft and align it with the airflow. The aircraft may further include a buoyancy controller configured to maintain the aircraft at a desired altitude. The aircraft of may further include a plurality of winches located at a front end and a rear end of the aircraft wherein the winches are tied to the tether and adapted to control pitch. The aircraft of may further include a supporting ring about the opening of the wind funnel and a plurality of ribs along the length of the wind funnel. In one embodiment, the primary body has a longitudinal blimp-like shape.

An aircraft including: a primary body filled with a lighter-than-air gas to provide buoyancy to the aircraft; a wind funnel defined within the primary body along a length of the primary body, a large end of the wind funnel located at a front of the aircraft and a small end of the wind funnel located approximately in the middle of the aircraft, the wind funnel positioned to concentrate airflow from the large end to the small end; a pivotless wind-to-electricity turbine coupled at the small end of the wind funnel wherein the turbine is ducted; and a tether coupled to the turbine to secure the aircraft to the ground and transmit electricity from the turbine to a ground station is provided.

In some embodiments, the turbine may be adapted to convert the airflow into electricity. Moreover, a rear end of the primary body opposite the large end of the wind funnel may be tapered and formed into a rudder. The tether may be secured to a winch on the ground wherein the winch is configured to adjust the altitude of the aircraft and align it with the airflow.

A system for generating electricity from airflow, including: a plurality of primary bodies filled with a lighter-than-air gas to provide buoyancy to each body; a wind funnel coupled along a length of each primary body, a large end of the wind funnel located at a front of each body and a small end of the wind funnel located approximately at a middle of each body, the wind funnel positioned to concentrate airflow from the large end to the small end; and a wind-to-electricity ducted turbine coupled at the small end of each wind funnel, wherein the plurality of primary bodies are connected together to form a truss is provided.

The system may further include a tether to secure the truss to the ground and transmit electricity therethrough. Each primary body may be spaced sufficiently away from one another to prevent combustion. The system may further include means to control the truss including, a winch, a power converters and a monitoring station. The altitude of each primary body may be controlled by an onboard computer and/or a wireless control system. A network system may coordinate each primary body such that the altitude of each primary body is coordinated relative to one another.

In another embodiment, a wind-to-power generator aircraft is provided comprising: a primary body filled with a lighter-than-air gas to provide buoyancy to the aircraft; a wind funnel coupled along a length of the primary body, a large end of the wind funnel located at a front of the aircraft and a small end of the wind funnel located approximately at a middle of the aircraft, the wind funnel positioned to concentrate airflow from the large end to the small end; a diffuser coupled along the length of the primary body, a large end of the diffuser located at a rear of the aircraft and a small end of the diffuser located approximately at the middle of the aircraft, the diffuser positioned to disperse airflow from the small end of the diffuser to the large end of the diffuser; a wind-to-electricity turbine positioned between the wind funnel and the diffuser and configured to convert the airflow passing from the wind funnel to the diffuser into electricity, the turbine having a first end coupled to the small end of the wind funnel and a second end coupled to the small end of the diffuser, wherein the turbine is ducted; and one or more tethers coupled to the aircraft to secure the aircraft to the ground and transmit electricity from the turbine to a ground station.

In one embodiment, the primary body of the aircraft has a tapered first end and a tapered second end and is comprised of light weight materials. In another embodiment the wind funnel and the diffuser are coupled along a bottom portion of the primary body. In yet another embodiment, the one or more tethers are configured to couple to one or more tether winches at the ground station that adjust the altitude of the aircraft. In one embodiment, the aircraft further comprises a plurality of pitch control lines to control the pitch of the aircraft, wherein a first pitch control line is coupled to a first pitch control tie point positioned approximately at the front middle of the aircraft and a second pitch control line is coupled to a second pitch control tie point positioned approximately at the middle underside of the aircraft.

In another embodiment, a module for generating electricity from airflow is disclosed, comprising: one or more primary bodies filled with a lighter-than-air gas to provide buoyancy to the module; a plurality of wind funnels coupled along a length of a truss, each of the plurality of wind funnels having a large end located at a front of the module and each of the plurality of wind funnels having a small end located approximately at a middle of the module, the plurality of wind funnels positioned to concentrate airflow from the large end to the small end of each of the plurality of wind funnels; a plurality of diffusers coupled along the length of the truss, each of the plurality of diffusers having a large end located at a rear of the module and each of the plurality of diffusers having a small end located approximately at the middle of the module, the plurality of diffusers positioned to disperse airflow from the small end to the large end of each of the plurality of diffusers; a plurality of wind-to-electricity turbines, wherein each turbine is positioned between one of the plurality of wind funnels and one of the plurality of diffusers, the turbines being configured to convert the airflow passing from the plurality of wind funnels to the plurality of diffusers into electricity, each of the plurality of turbines having a first end coupled to the small end of each of the plurality of wind funnels and each of the plurality of turbines having a second end coupled to the small end of each of the plurality of diffusers, wherein the turbines are ducted; wherein the truss is configured to secure the one or more primary bodies, the plurality of diffusers, the plurality of wind funnels, and the plurality of wind-to electricity turbines; and one or more tethers coupled to the module to secure the module to the ground and transmit electricity from the plurality of turbines to a ground station.

In one embodiment, the truss of the module secures three primary bodies, six wind funnels, six diffusers, and six turbines. In another embodiment, the module further comprises a plurality of pitch control lines to control the pitch of the module, wherein a first pitch control line is coupled to a first pitch control tie point positioned approximately at the front middle of the module and a second pitch control line is coupled to a second pitch control tie point positioned approximately at the middle underside of the module. In another embodiment, the one or more tethers are configured to couple to one or more tether winches at the ground station that adjust the altitude of the aircraft. In another embodiment, the plurality of wind-to-electricity turbines have either a multi-blade impeller or a paddle-wheel design.

In another embodiment, a module array for generating electricity from airflow is provided, comprising a plurality of modules interconnected to one another with one or more tethers, wherein each of the plurality of modules comprises: one or more primary bodies filled with a lighter-than-air gas to provide buoyancy to each of the plurality of modules; a plurality of wind funnels coupled along a length of a truss, each of the plurality of wind funnels having a large end located at a front of the module and each of the plurality of wind funnels having a small end located approximately at a middle of the module, the plurality of wind funnels positioned to concentrate airflow from the large end to the small end of each of the plurality of wind funnels; a plurality of diffusers coupled along the length of the truss, each of the plurality of diffusers having a large end located at a rear of the module and each of the plurality of diffusers having a small end located approximately at the middle of the module, the plurality of diffusers positioned to disperse airflow from the small end to the large end of each of the plurality of diffusers; a plurality of wind-to-electricity turbines, wherein each turbine is positioned between one of the plurality of wind funnels and one of the plurality of diffusers, the turbines being configured to convert the airflow passing from the plurality of wind funnels to the plurality of diffusers into electricity, each of the plurality of turbines having a first end coupled to the small end of each of the plurality of wind funnels and each of the plurality of turbines having a second end coupled to the small end of each of the plurality of diffusers, wherein the turbines are ducted; wherein the truss is configured to secure the one or more primary bodies, the plurality of diffusers, the plurality of wind funnels, and the plurality of wind-to electricity turbines, and wherein the one or more tethers secure the module array to a ground station and transmit electricity from the plurality of wind-to-electricity turbines of the plurality of modules to the ground station.

In one embodiment, each truss of the plurality of modules of the module array secures three primary bodies, six wind funnels, six diffusers, and six turbines. In another embodiment, each of the plurality of modules are spaced sufficiently away from adjacent modules to prevent collateral damage. In another embodiment, the one or more tethers are configured to couple to one or more tether winches at the ground station that adjust the altitude of the module array. In another embodiment, the module array further comprises a plurality of pitch control lines to control the pitch of the plurality of modules in the module array, wherein a first pitch control line is coupled to a first pitch control tie point positioned approximately at the front middle of each of the plurality of modules and a second pitch control line is coupled to a second pitch control tie point positioned approximately at the middle underside of each of the plurality of modules. In one embodiment, the wind-to-electricity turbines of each of the plurality of modules have a paddle-wheel design.

A ground station for receiving electricity from one or more modules configured to generate electricity from airflow is also disclosed, comprising: one or more tether winches that each reel a tether coupled to the one or more modules, each tether configured to adjust the altitude of the one or more modules; a plurality of carriages that each support the one or more tether winches, each of the one or more carriages having a plurality of wheels that engage with a track; and a bridge support structure that interconnects the plurality of carriages. In one embodiment, the ground station further comprises: an inner track and an outer track; and two outer carriages and a central carriage that each support one tether winch, wherein the two outer carriages have wheels that engage with the outer track, and the central carriage includes wheels that engage with the inner track, the two outer carriages configured to move about the outer track and the central carriage configured to move about the inner track to allow the one or more modules to rotate up to 360 degrees in direction, wherein the bridge support structure interconnects the two outer carriages and the central carriage with one another.

In one embodiment, the ground station further comprises: one or more pitch control winches operative to reel in and out a pitch control line coupled to the one or more modules, each pitch control line configured to adjust the pitch of the one or more modules. In one embodiment, wherein the outer track and the inner track are each comprised of an upper rail and a lower rail.

### BRIEF DESCRIPTION OF THE DRAWINGS

FIG. 1 illustrates a side view of an embodiment of an aircraft for converting air to electricity according to the invention.

FIG. 2 illustrates a bottom view of the aircraft of FIG. 1

FIG. 3 illustrates a front view of the aircraft of FIG. 1.

FIG. 4 illustrates a back view of the aircraft of FIG. 1.

FIG. 5 illustrates a bottom view of a first alternative embodiment of an aircraft for converting air to electricity according to the invention.

FIG. 6 illustrates a side view of the aircraft of FIG. 5.

FIG. 7 illustrates a side view of a second alternative embodiment of an aircraft for converting air to electricity according to the invention.

FIG. 8 illustrates a prospective view of a configuration of a plurality of aircrafts for converting air to electricity according to the invention.

FIG. 9 illustrates an embodiment of an aircraft adapted to house a wind funnel and a diffuser to generate electricity from wind.

FIG. 10 illustrates a front, topside perspective view of a module comprising six wind funnels, six diffusers, six turbines, and three buoyant bodies attached to a truss.

FIG. 11 illustrates a front, underside perspective view of the module.

FIG. 12 illustrates a back, underside perspective view of the module.

FIG. 13 illustrates a perspective view of a module array comprising a plurality of modules interconnected to one another.

FIG. 14 illustrates a perspective view of one embodiment of a ground station to which a module array may be attached.

FIGS. 15 and 16 illustrate perspective views of a portion of the ground station and its components.

FIG. 17 illustrates a cross-sectional view of one of the tracks of the ground station.

FIGS. 18-22 illustrate embodiments of various turbine and impeller designs.

### DETAILED DESCRIPTION OF THE INVENTION

In the following detailed description of the invention, numerous specific details are set forth in order to provide a thorough understanding of the invention. However, the invention may be practiced without these specific details. In other instances well known methods, procedures, and/or components have not been described in detail so as not to unnecessarily obscure aspects of the invention.

One aspect of the present invention provides an aircraft adapted to house a wind funnel and a wind turbine configured to convert the airflow through the wind funnel into electricity. An electrical cable between the aircraft and a ground station transfers the generated electricity from the aircraft to the receiving ground station for distribution.

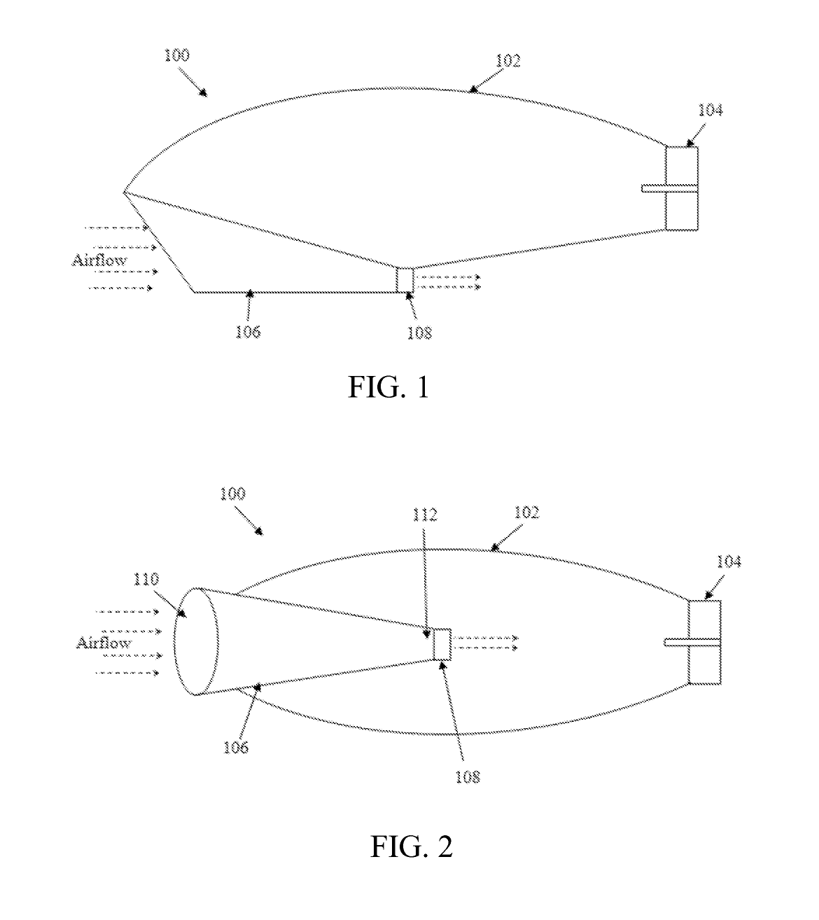

FIGS. 1, 2, and 3 illustrate different views of an aircraft 100 (e.g., blimp) adapted to house a wind funnel turbine according to one embodiment. FIG. 1 illustrates a side view of an embodiment of an aircraft for converting air to electricity according to the invention. The aircraft 100 may include a primary buoyant body 102 that may be filled with a lighter-than-air gas to cause the aircraft to float in air. Different types of gases which have a density lower than air may be used to fill the primary buoyant body 102. An example of such a gas includes, but is not limited to, helium. A tail rudder and/or stabilizing guides 104 may be coupled at the rear of the aircraft 100. A funnel 106 may be coupled lengthwise along a bottom portion of the aircraft 100, with a large opening end 110 of the funnel 106 at the front of the aircraft 100 and a small opening end 112 of the funnel 106 pointed toward the rear of the aircraft 100 (see FIG. 2). In some embodiments, the small opening end 112 is situated approximately intermediate between the front end and the rear end of the aircraft 100. The funnel 106 may be made from a thin, light-weight material. An example of such material includes, but is not limited to, an aluminum and polyethylene film laminate. A turbine 108 (including impeller blades and a generator) may be coupled to the small end 112 of the funnel 106 to convert air flowing through the funnel 106 from the large opening end 110 to the small opening end 112 into electricity. In some embodiments, the turbine 108 is ducted.

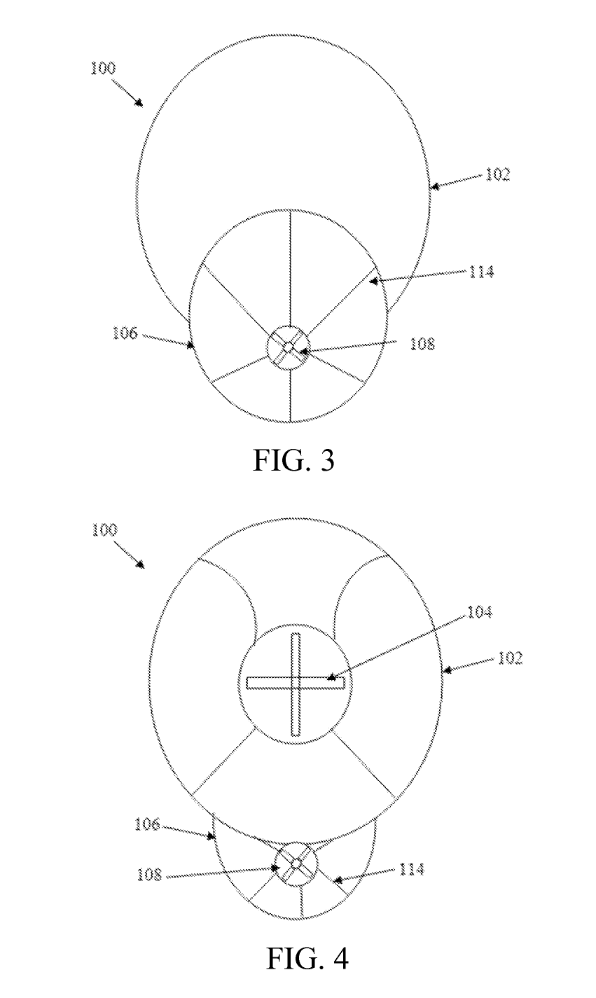

FIG. 3 illustrates a front view of the aircraft 100 described with reference to FIG. 1. FIG. 4 illustrates a back view of the aircraft 100 described with reference to FIG. 1. As shown, a plurality of ribs (or spars) 114 may be attached to or incorporated within the wind funnel 106. The ribs 114 may be positioned longitudinally relative to the wind funnel 106. In one aspect, the ribs 114 may provide a reinforcing function to stabilize the wind funnel 106. Additionally, a reinforcing ring (not shown) may be attached to or incorporated within a mouth of the wind funnel 106, preferably at the mouth of the large opening end 110. Such ring may additionally provide reinforcement to the wind funnel 106. Overall, however, few rigid structures exist on the aircraft 100.

Using the funnel 106 to concentrate airflow into the small end 112 provides several advantages and improvements over the prior art. One advantage is that the use of the wind funnel 106 provides a self-orientation feature to the aircraft 100. That is, having the large opening end 110 at the front of the aircraft 100 causes the aircraft 100 to orient (or align) itself with the flow of air. Furthermore, the aircraft 100 may be tethered to the ground so that it maintains a relatively fixed position, while allowing the aircraft 100 to be self-oriented. The aircraft 100 may be maintained at a high altitude (e.g., a thousand feet or more from ground or sea level) by its tether (not shown). The tether may serve as the conduit for transmitting the electricity generated by the turbine 108 from the turbine 108 to a receiving station located on the ground.

Another advantage in using the wind funnel 106 is that it allows for using lighter wind turbines so that the aircraft 100 can more easily lift while still profitably producing electricity. The funnel 106 allows reducing the size of the turbine blades required to power the generator thereby improving performance. Although other high altitude wind generators have been designed, their large blade size or the mechanism used to turn their generator make them ungainly and unfeasible. The funnel shape is used to increase and concentrate the force of the wind on the turbine blades of turbine 108 thus allowing for shorter, lighter blades. Use of the wind tunnel 106 concentrates airflow through the small opening 112 which allows for the use of smaller turbine blades. The funnel 106 also allows for increased performance at low wind speeds and because the turbine is ducted, the blades can be smaller and lighter allowing for a smaller aircraft size and increased efficiency. The funnel can be shaped with a circular or triangular throat and its longitudinal section can be straight or curved, depending upon specific aerodynamic efficiencies and structural considerations.

The turbine 108 is considerably lighter in weight (in relation to the prior art) by using ultra-light weight materials and eliminating several unneeded parts. For example, the turbine does not need a pivot mechanism because pivoting is done from the ground via a tether connection on the ground. Additionally, less gearing is used in the turbine 108 because the blades of the turbine 108 are capable of achieving higher blade speeds (i.e., from using the funnel 106) thereby resulting in a smaller and lighter gearbox for the turbine. Additionally, in contrast to the massive bearings required by larger prior art turbine blades, the smaller and lighter blades utilize smaller bearings to support them. The turbine 108 may be located near the center bottom of the aircraft 100.

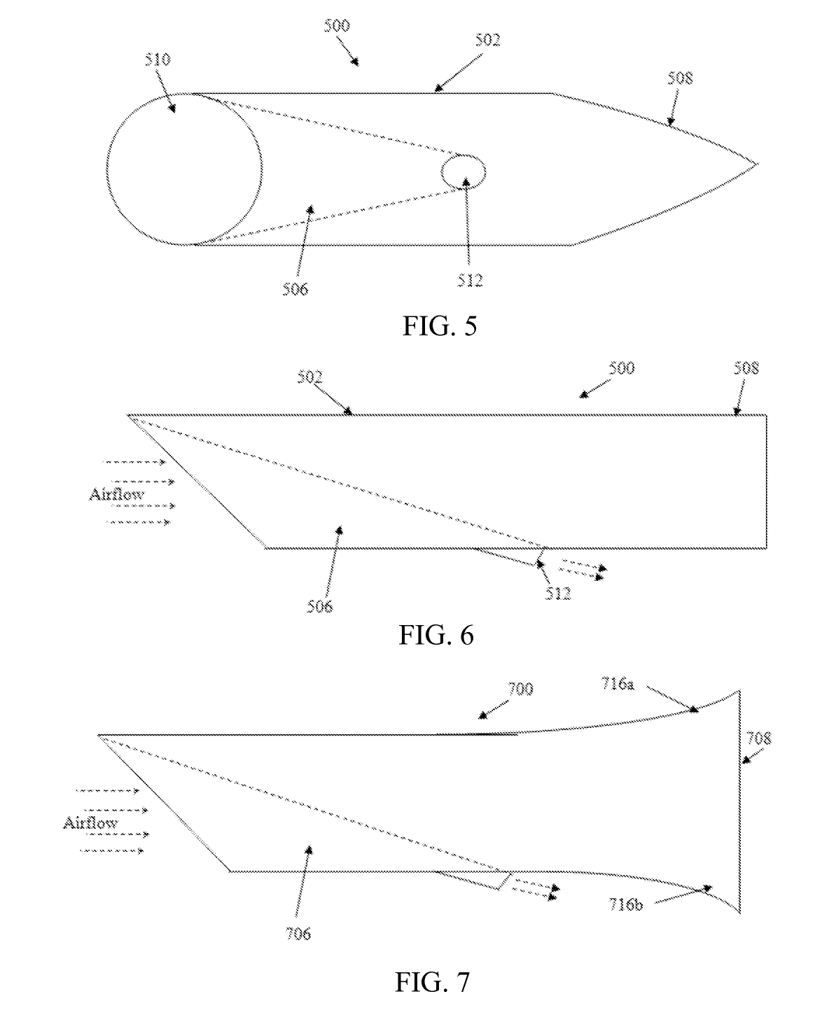

FIGS. 5 and 6 illustrate an alternative embodiment of an aircraft 500 adapted to house a wind funnel according to one example. The aircraft 500 may include a round longitudinal body 502 with a large end opening 510 at one end and a tapered end 508 at the other end. The longitudinal body 502 may be filled with a lighter-than-air gas to provide buoyancy to the aircraft 500. The longitudinal body 502 may house a wind funnel 506 within the large end opening 510 at the front of the aircraft 500 and the small end opening 512 approximately midway along the longitudinal body 502 on the bottom side. Alternatively, the wind funnel 506 may be integral with the body 502. That is, the large end opening 510 and the small end opening 512 may themselves comprise a funnel chamber of the funnel 506. This configuration is intended to keep the center of mass balanced under the center of lift. The large opening 510 may be angled (as illustrated in FIG. 6) to increase the effective area through which air may enter. A turbine may be located at or near the small opening 512, so that it is turned by the force of the air being funneled out of the small end 512. As the airflow turns the turbine, it generates electricity which is then distributed to a ground station via an electrically conductive tether.

FIG. 7 illustrates an alternative embodiment of the aircraft illustrated in FIGS. 5 and 6. In this example, the aircraft 700 also houses a wind funnel 706 which concentrates airflow from a large end to a small end to cause a turbine to convert wind force to electricity. The tail end 708 is tapered (as illustrated in FIG. 5) and guidance rudders 716a and 716b are formed thereon. In one example, the rudders 716a and 716b may be formed from the pinching of the tapered tail end 708.

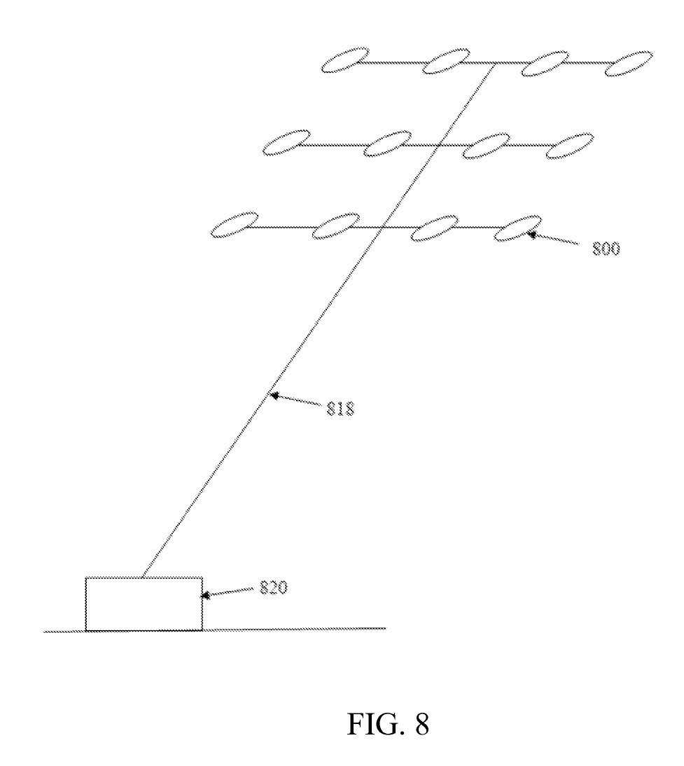

In various configurations, the aircraft 100, 500 and/or 700 may be used as a sole power generator. However, other embodiments may implement a module of two, four, eight, or more aircraft 100 that may be stacked wherein one tether serves as the anchor to the ground and conduit of electricity generated by each of the turbines collected and passed therethrough. FIG. 8 illustrates an example of how a plurality of wind-to-power aircraft 800 may be arranged in groups and coupled to a single tether 818 that secures the aircraft 800 to a ground station 820. The aircraft 800 may be “stacked” up to an altitude where buoyancy and/or power generation are no longer efficient, possibly up to fifty thousand feet. The aircrafts 800 are stacked at a safe separation or distance from one another in case of combustion. Aircraft 800 may be paired so that their turbines and blades counter rotate. That is, by having the blades of a first aircraft rotate in a counter direction to the blades of a corresponding second aircraft, the whole set of aircraft may be prevented from turning.

Ground control may include a large winch, power converters/transformers and a monitoring station 820. The tether winch of this size may be designed in a plurality of configurations. In one implementation, the tether may be coiled around a very large drum such that the plurality of aircraft pivot together with the wind. In another implementation, the tether may be coiled into a large round “basket” wherein pivoting is limited to the pressure rollers (i.e., the pressure rollers maintain tension on the tether and provide gentle curves to coil the tether into the “basket”). The tether winch allows for controlling the altitude of the aircraft or aircrafts, e.g., raising and lowering of aircraft modules. Power may be transmitted down the tether wherein in the tether is (at least partly), or functions as, a coaxial wire. Due to the high altitude of these aircraft (e.g., 1000 feet, 5000 feet, 10000 feet, 20000 feet, 30000 feet, etc.), warning lights may be placed along the tether and/or aircraft.

An aircraft's directional altitude may also be controlled by small on-board winches that tie the blimp to the main tether. These winches may be located and attached to the fore and aft of the aircraft to control pitch. If a single aircraft is aloft, the main attachment point for the tether may be under the turbine 108 (FIG. 1). If two or more aircraft are aloft, then the main attachment point for the tether is at the middle of a truss, where the aircraft are coupled on either end of the truss. The truss then is perpendicular to the direction of the flow of wind. Additional pairs of aircraft can be attached with the tether connected to the middle of the truss. Altitude can also be controlled with the aircraft rudder and/or elevators 104. All altitude controls (rudder, elevator and fore/aft winches) may be coordinated and/or controlled with an onboard computer or a wireless (remote) control system. Where a plurality of aircraft are deployed (as illustrated in FIG. 8), their controls may be networked so that their altitude is coordinated. Buoyancy may be maintained by a small on-board helium or hydrogen generator and/or storage tank.

### Multi-Funnel Aircraft Featuring a Diffuser

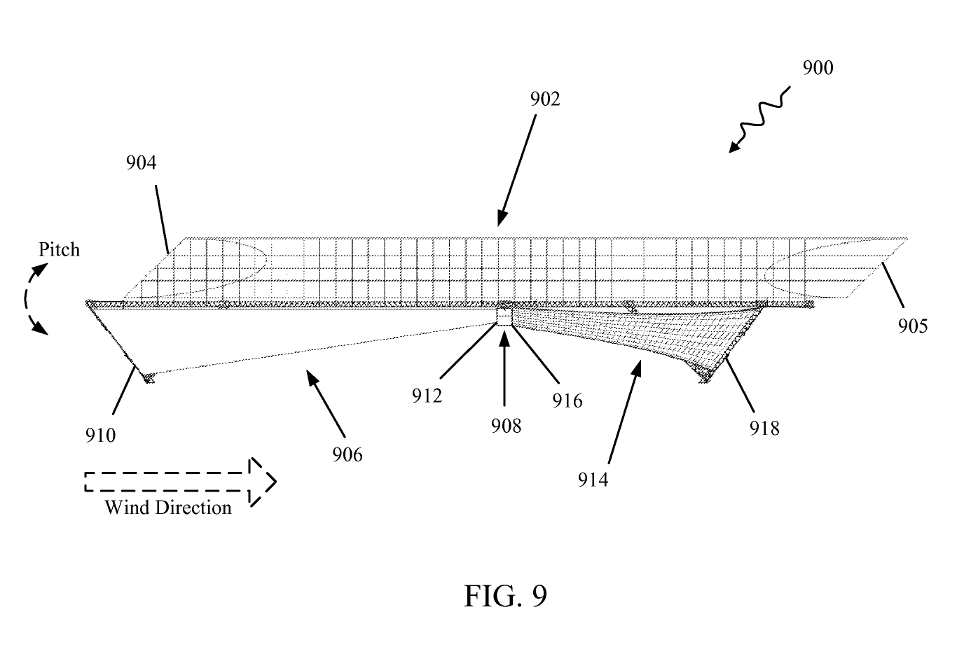

FIG. 9 illustrates an embodiment of an aircraft 900 adapted to house a wind funnel and a diffuser that generates electricity from wind. The aircraft 900 may include a primary buoyant body 902, a tapered front end 904, a tapered back end 905, a wind funnel (also known as a collector) 906, a turbine 908, and a diffuser 914. The buoyant body 902 may be filled with a gas, for example helium, that is lighter than the ambient air surrounding it to provide lift for the aircraft 900. Air flows through the wind funnel 906 and past the turbine 908 to generate electricity. The turbine 908 may be coupled lengthwise along a bottom portion of the aircraft 900. The wind funnel 906 comprises a first opening 910 that is at least as large as a second opening 912. The first opening is oriented towards the front of the aircraft 900, while the second opening 912 is oriented towards the rear of the aircraft 900. The wind funnel 906 may be made from thin, light-weight materials. An example of such materials include, but are not limited to, aluminum and polyethylene film laminate.

The wind funnel's 906 second opening 912 couples to the turbine 908 (including impeller blades and a generator). The air flowing through the wind funnel 906 from the first opening 910 to the second opening 912 drives the turbine 908 to generate electricity. In one embodiment the turbine 908 is ducted. The diameter of the first opening 910 may be one or more times greater than the diameter of the second opening 912. In one embodiment, the turbine 908 is positioned at approximately the midpoint of the aircraft 900. In other embodiments the turbine 908 may be positioned closer to the front or rear of the aircraft 900.

In one embodiment, a diffuser 914 is coupled to the other end of the turbine 908 and serves as a type of exhaust to aerodynamically channel air flowing out of the turbine 908. Specifically, the sub-atmospheric pressure within the diffuser 914 draws more air past the blades of the turbine 908, and hence more power can be generated compared to a turbine of the same rotor blade diameter lacking a diffuser. The diffuser is coupled to the turbine 908 through the diffuser's first opening 916. The diffuser 914 allows air flowing past the turbine's 908 blades to flow through the first opening 916 and out through the second opening 918. The diameter of the second opening 918 may be at least one or more times greater than the diameter of the first opening 916, and thus the cross sectional area of the diffuser increases along the direction of the wind flow. In one embodiment, the aircraft 900 may include a tapered front end 904 and a tapered back end 905 whose aerodynamic properties help align and orient the aircraft 900 with the flow of air.

Among other things, the following properties of the wind funnel 906 and diffuser 914 may be varied in different embodiments of the aircraft 900 to achieve different performance metrics in different environments: the ratio between the diameter of the wind funnel's first opening 910 to the diameter of the wind funnel's second opening 912; the ratio between the diameter of the wind funnel's first opening 910 to the diameter of the fan blades (not shown) of the turbine 908; the ratio between the diameter of the diffuser's first opening 916 to the diameter of the diffuser's second opening 918; the ratio between the diameter of the diffuser's second opening 918 to the diameter of the fan blades (not shown) of the turbine 908; the ratio between the diameter of the wind funnel's first opening 910 to the diameter of the diffuser's second opening 918; and the ratio between the length of the wind funnel 906 and the length of the diffuser 914.

### Module and Array

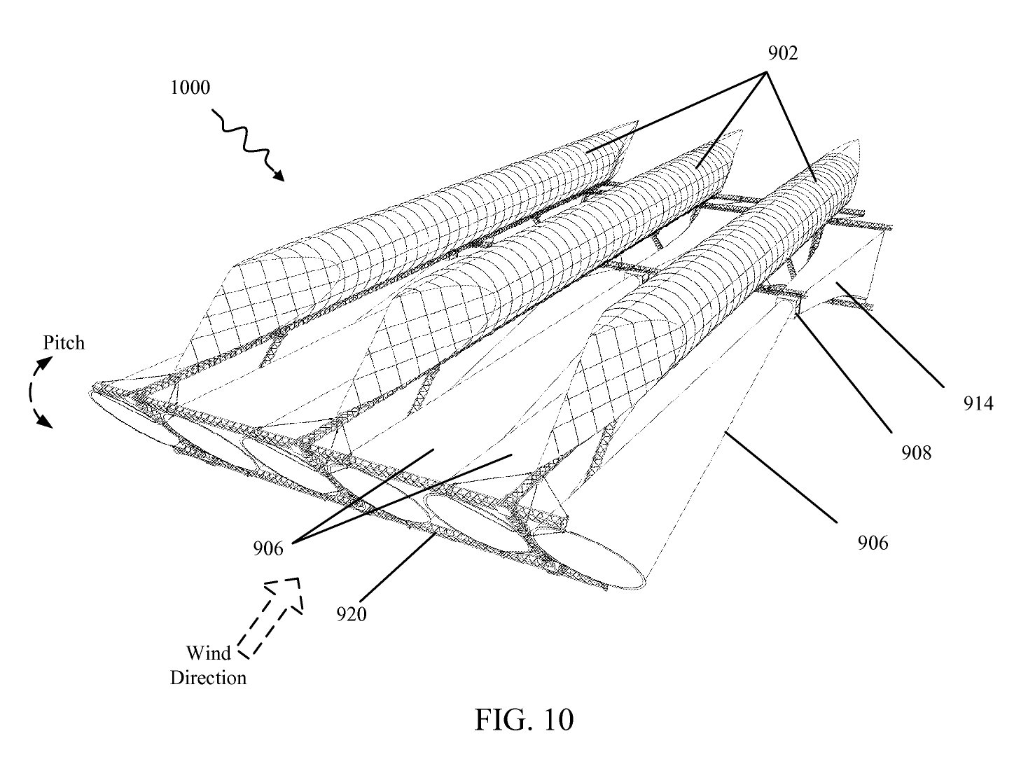

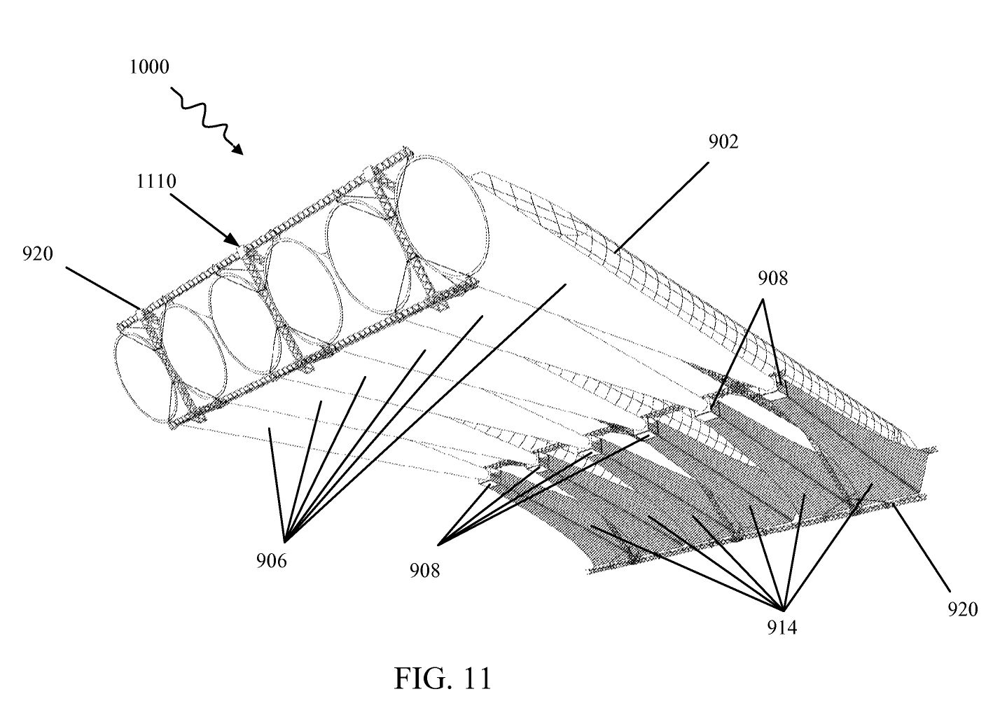

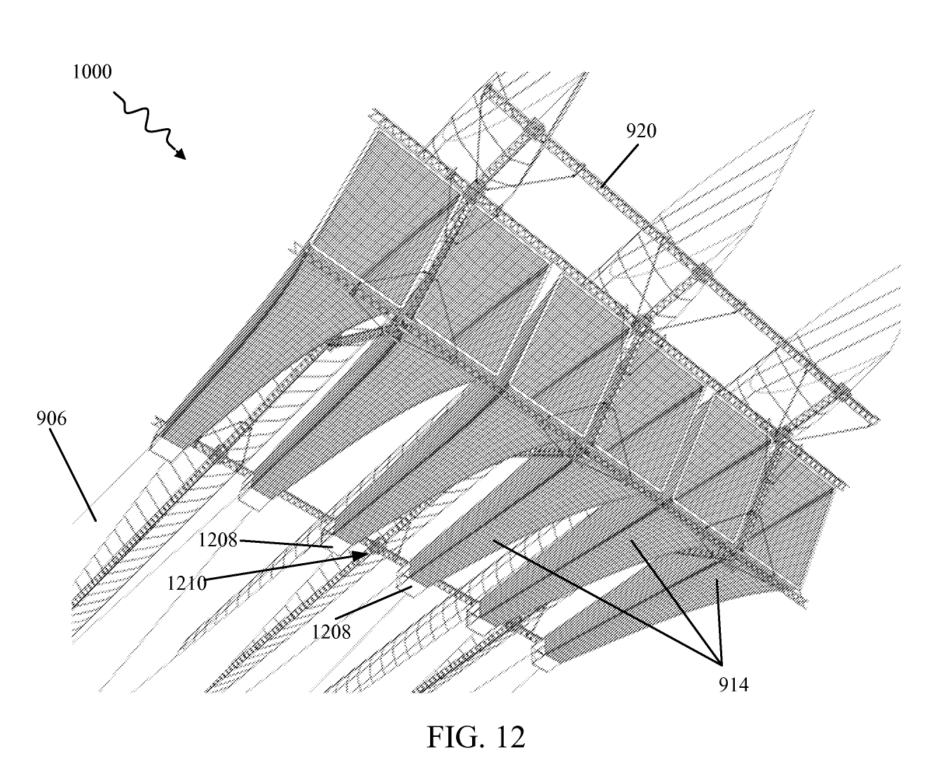

FIG. 10 illustrates a front, topside perspective view of six wind funnels 906, six diffusers 914, six turbines 908, and three buoyant bodies 902 attached to a truss 920 that form one embodiment of a module 1000. FIG. 11 illustrates a front, underside perspective view of the module 1000. FIG. 12 illustrates a back, underside perspective view of the module 1000. The truss 920 may comprise any one or more rigid, lightweight materials such as aluminum, plastic, or other lightweight metal or metal alloys to secure the plurality of wind funnels 906, diffusers 914, turbines 908, and buoyant bodies 902 to one another. By having a plurality of turbines 908, the module 1000 generates more electricity than a single turbine design. The diffusers 914 of the module 1000 each aerodynamically channel the airflow coming out of each turbine 908 away and out the rear of the module 1000. In this fashion, airflow coming out of one turbine 908 does not disrupt the airspace immediately behind an adjacent turbine 908 in the module 1000.

In other embodiments, the module 1000 may comprise more or fewer than: three buoyant bodies, six wind funnels, six diffusers, and six turbines. For example, in another embodiment, the module 1000 may comprise three buoyant bodies, and nine wind funnels, nine diffusers, and nine turbines. In the embodiments shown in FIGS. 10 and 11, the cross section of the wind funnels 906 are substantially circular and the cross section of the diffusers 914 are substantially rectangular. In other embodiments, the wind funnels 906 may be elliptical, square, or rectangular. In yet other embodiments, the diffusers 914 may be circular, elliptical, or square.

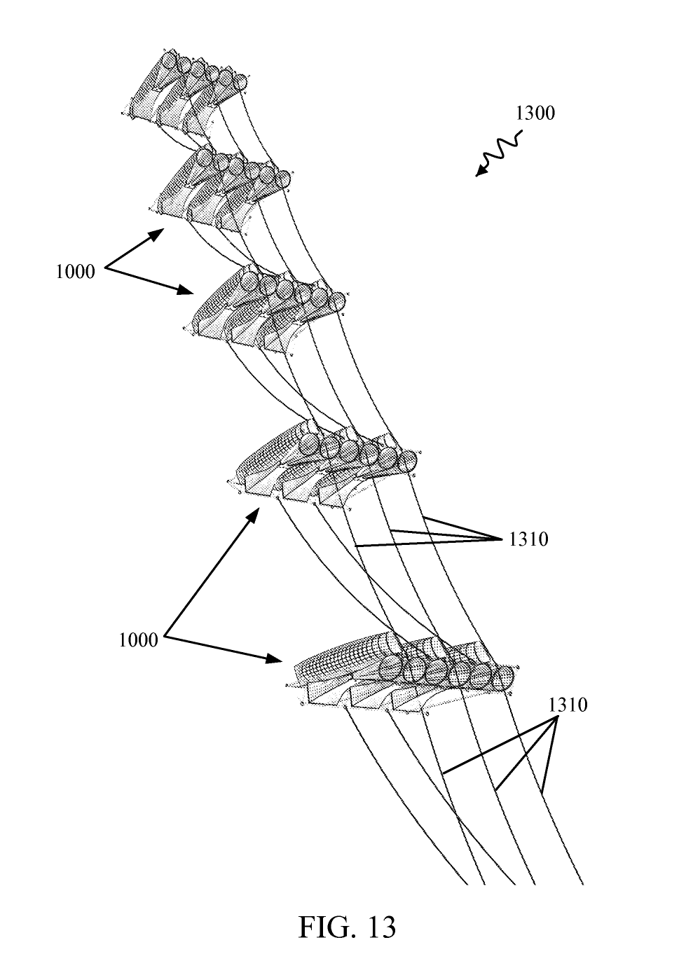

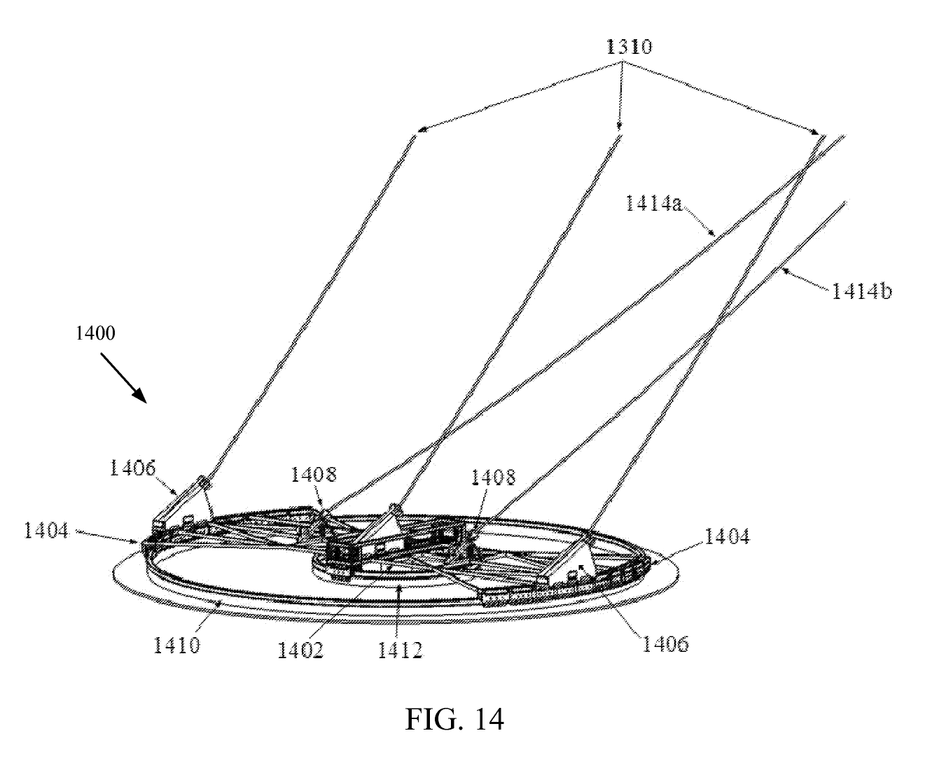

FIG. 13 illustrates a perspective view of a module array 1300 comprising a plurality of modules 1000 interconnected to one another and a ground station (shown in FIG. 14) using a plurality of tethers 1310. (The diffuser 914 sections of the modules 1000 have been removed for clarity). The tethers 1310 help secure the modules 1000 to one another and the ground station, and also act as a conduit to transmit electricity generated by the turbines of the modules 1000 to the ground station. The modules 1000 are “stacked” a safe distance apart from one another, for example a thousand feet, to prevent tangling of the modules 1000 and damage from combustion/fire. In one embodiment, the module array 1300 is secured by three tethers. In other embodiments, one or more tethers may be used.

### Ground Station

FIG. 14 illustrates a perspective view of one embodiment of a ground station 1400 to which a module array 1300 may be attached. Among other things, the ground station 1400 serves to transmit the electricity generated by one module 1000 or a module array 1300 to one or more transformers, and secures the one or more modules 1000 to the ground. The three tethers 1310 are the primary means by which the one or more modules 1000 are secured to the ground station 1400. The tethers 1310 also serve as a conduit to transmit the electricity generated by the turbines 908 of the one or more modules 1000 to the ground station 1400. The ground station 1400 may include a bridge support structure 1402, carriages 1404, tether winches 1406, pitch control winches 1408, power converters/transformers, and a monitoring station.

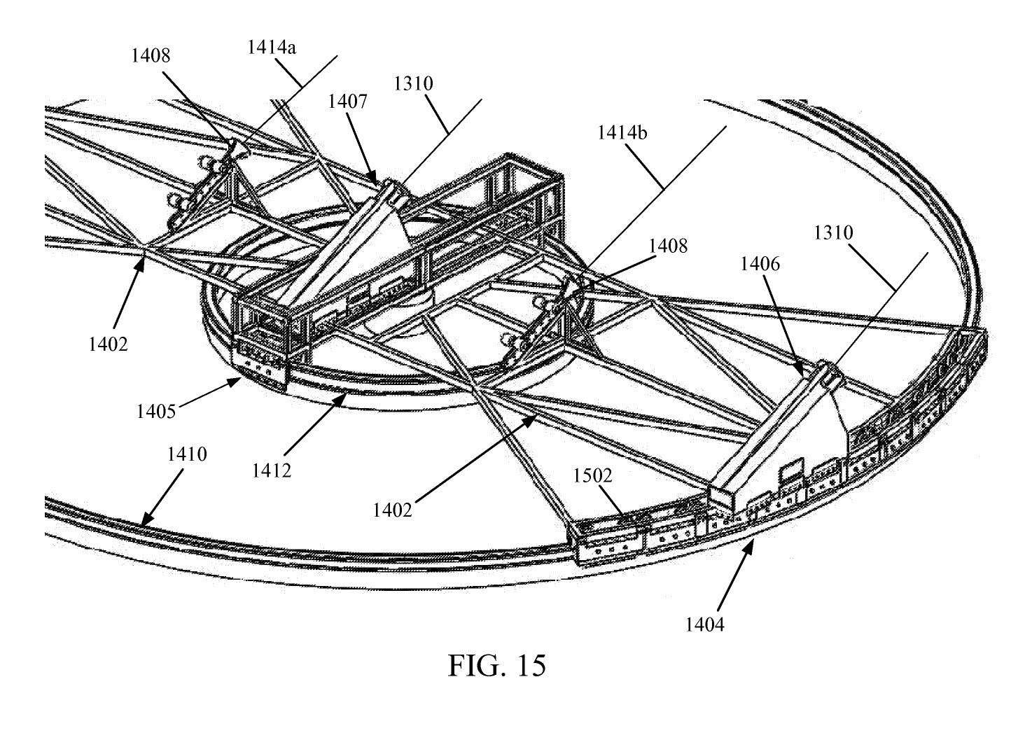

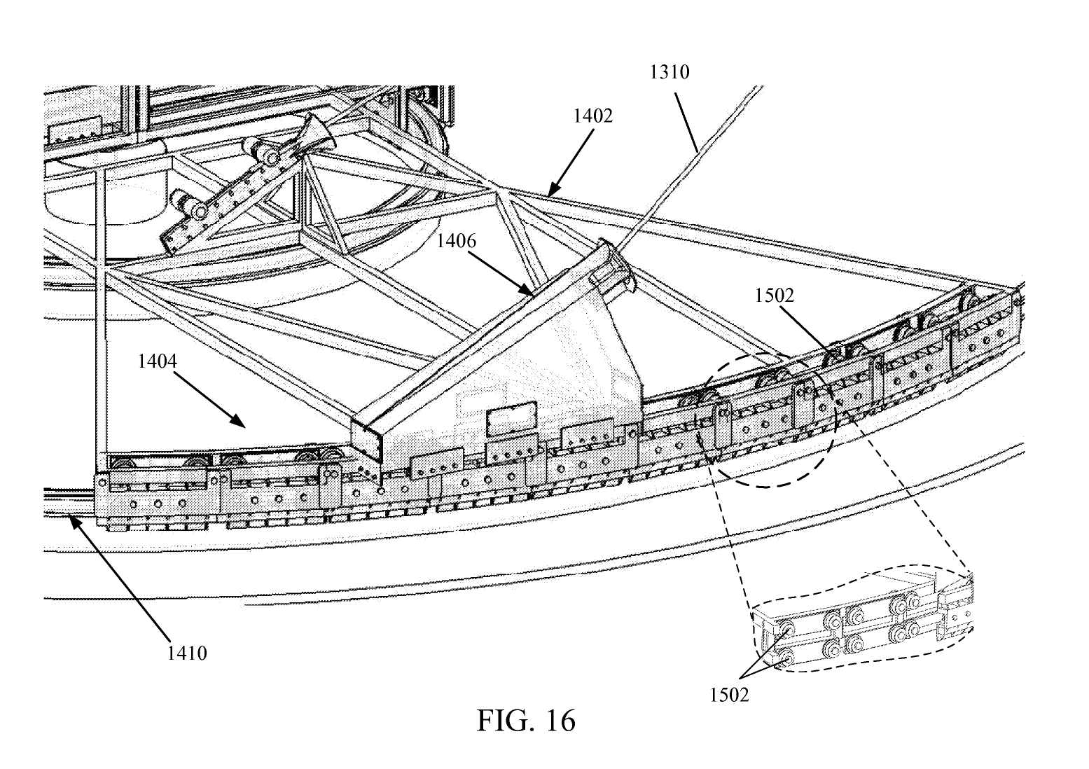

FIGS. 15 and 16 illustrate perspective views of a portion of the ground station 1400 and its components. In one embodiment, the ground station 1400 comprises three tether winches 1406 and 1407. Each of the two tether winches 1406 are coupled to a corresponding outer carriage 1404 and the third tether winch 1407 is coupled to a central carriage 1405. The two outer carriages 1404 and the central carriage 1405 are interconnected to each other through the bridge support structure 1402. The two outer carriages 1404 rest on an outer track 1410, and the central carriage 1405 rests on an inner track 1412. Each carriage 1404 and 1405 comprises a plurality of wheels 1502 that engage with their respective tracks 1410 and 1412 and allow the carriages 1404 and 1405 to move along the tracks 1410 and 1412. In one embodiment, the carriages 1404, 1405 are free to move along the tracks 1410, 1412 as the module array 1300 changes direction and location in response to a corresponding change in the direction of the wind. Thus, the module array 1300 is capable of always facing the direction of airflow to maximize electricity production, since the ground support station 1400 to which it is attached allows it to change 360 degrees in direction. Moreover, if desired, the carriages 1404, 1405 feature brakes that allow them to be locked in place anywhere along the tracks 1410, 1412. FIG. 16 also illustrates a cutaway view of one embodiment of the outer carriage 1404 exposing the wheels 1502 underneath.

Referring to FIGS. 14-16, the bridge support 1402 may be comprised of rigid support members, such as, steel beams that interconnect to each other to form the bridge support 1402. The bridge support 1402 helps secure the outer carriages 1404 and the central carriage 1405 to one another so that the three carriages 1404, 1405 rotate along the tracks 1410, 1412 together. The carriages 1404 and 1405 support the tether winches 1406 and 1407. The tether winches 1406 and 1407 are configured to reel in or reel out the tethers 1310 that are attached to the one or more modules 1000 thereby controlling the altitude of the one or more modules 1000. The power converters/transformers receive the electricity generated by the one or more modules and may transmit the electrical power to remote locations after voltage/current regulation and/or conversion. In one embodiment, the ground station features a monitoring station that allows personnel and/or automated workstations to monitor various performance and safety metrics.

The pitch control winches 1408 are also secured to corresponding structures along the bridge support 1402. The pitch control winches 1408 are configured to reel in or reel out the pitch control lines 1414a, 1414b that are connected at strategic points along the one or more modules 1000 in order to control the pitch and to some extent the roll of the aircraft 900 and modules 1000 (see FIGS. 9 and 10). Referring to FIGS. 11 and 12, a first pitch control tie point 1110 is shown located near the front middle of the module 1000. A second pitch control tie point 1210 is shown located near the middle, underside of the module 1000. The first and second pitch control tie points 1110 and 1210 are sturdy tie points that each tether a pitch control line 1414a, 1414b. For example, one pitch control line 1414a may be tethered to the first pitch control tie point 1110, and another pitch control line 1414b may be tethered to the second pitch control tie point 1210. By reeling in the pitch control line 1414a the front side (the side near the wind funnel 906) of the module 1000 will point more towards the ground, thereby causing the module 1000 to pitch down. By contrast, reeling out the pitch control line 1414b will cause the front side of the module 1000 to tilt upward towards the sky, thereby causing the module 1000 to change pitch in the other direction. Controlling the pitch of the aircraft 900 or module 1000 may help orient the aircraft 900 or module 1000 against the airflow and optimize the energy generated by the turbines 908.

Moreover, although FIG. 11 shows the first pitch control tie point 1110 as located near the truss 920, the tie point 1110 may be located anywhere near the front, middle of the module. Similarly, FIG. 12 shows the second pitch control tie point 1210 located near the truss 920. Instead, the tie point 1210 may be located anywhere near the middle underside (e.g., close to the center of gravity) of the module 1000. For example, the tie point 1210 may be affixed to an outer portion of one of the turbines 1208 closest to the center of the module 1000. Also, the modules 1000 have kite-like properties that provide lift so that the modules 1000 maintain a vertical attitude facing the airflow, and are not significantly pushed down by the airflow.

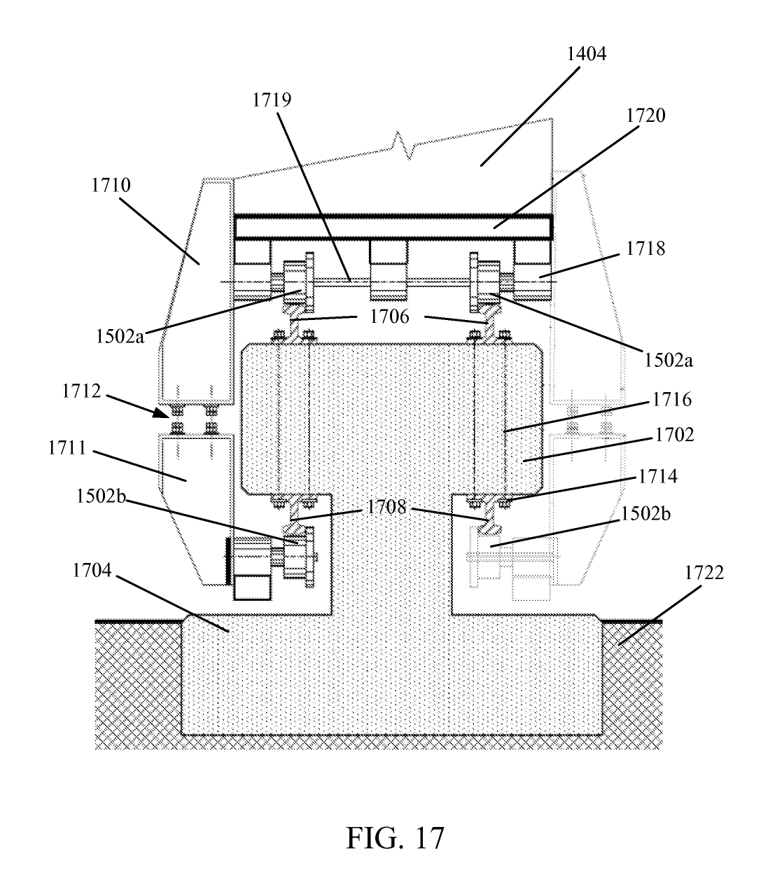

FIG. 17 illustrates a detailed cross sectional view of one embodiment of the carriage 1404 resting on the outer track 1410. The carriage 1405 resting on the inner track 1412 may have a similar cross sectional view and components. FIG. 17 illustrates a concrete pier 1702, a concrete base 1704, upper rails 1706, lower rails 1708, upper steel wheels 1502a, lower steel wheels 1502b, upper vertical connectors 1710, lower vertical connectors 1711, vertical connector height adjustment bolts 1712, rail mount bolts 1714, embedded rail mount studs 1716, bearing blocks 1718, upper wheel shaft 1719, and a carriage bed 1720. The carriage 1404 rests atop the carriage bed 1720, and in one embodiment both the carriage 1404 and the bed 1720 are secured to the upper vertical connectors 1710. The upper vertical connectors 1710 are secured to the lower vertical connectors 1711 through at least the vertical connector height adjustment bolts 1712. The vertical connector height adjustment bolts 1712 allow the distance separating the upper and lower vertical connectors 1710 and 1711 to increased or decreased.

The upper rails 1706 and lower rails 1708 are secured to the concreter pier 1702 through the use of rail mount bolts 1714 and embedded rail mount studs 1716. For clarity, not all rail mount bolts and embedded rail mount studs have been labeled. The embedded rail mount studs 1716 are embedded within the concrete pier 1702 and in one embodiment connect the rail mount bolts 1714 of an upper rail 1706 to the rail mount bolts 1714 of a lower rail 1708, as depicted in FIG. 17. The upper steel wheels 1502a rest on the upper rails 1706 and ride along the upper rails 1706 so that the carriage 1404 can move around the outer track 1410. The upper steel wheels are connected to an upper wheel shaft and bearing blocks 1718. The lower steel wheels 1502b rest against the lower rails 1708 and turn along the lower rails 1708 allowing the carriage 1404 to again move around the outer track 1410. By having two pairs of rails and wheels, i.e., a plurality of upper steel wheels 1502a resting on a pair of upper rails 1706 and a plurality of lower steel wheels 1502b resting against a pair of lower rails 1708, the carriage 1404 is secured to the outer track 1310 against the vertical forces imparted by the module array 1300 that may pull on the carriage 1404 via the attached tether winches 1306. Thus, the over-under configuration of the wheels 1502a, 1502b and the ground station 1400 as a whole allow the module array 1300 to pivot into the wind as the direction of the wind changes from one direction to another.

The concrete pier 1702 serves as the main support structure for the various components of the outer track 1410 and carriage 1404. In one embodiment, the concrete pier 1702 has a concrete base 1704 that is embedded deep within the compacted ground 1722. All of the components and structures described above in reference to the outer track 1410 and carriage 1404 may be used for the inner track 1412 and corresponding carriage 1405.

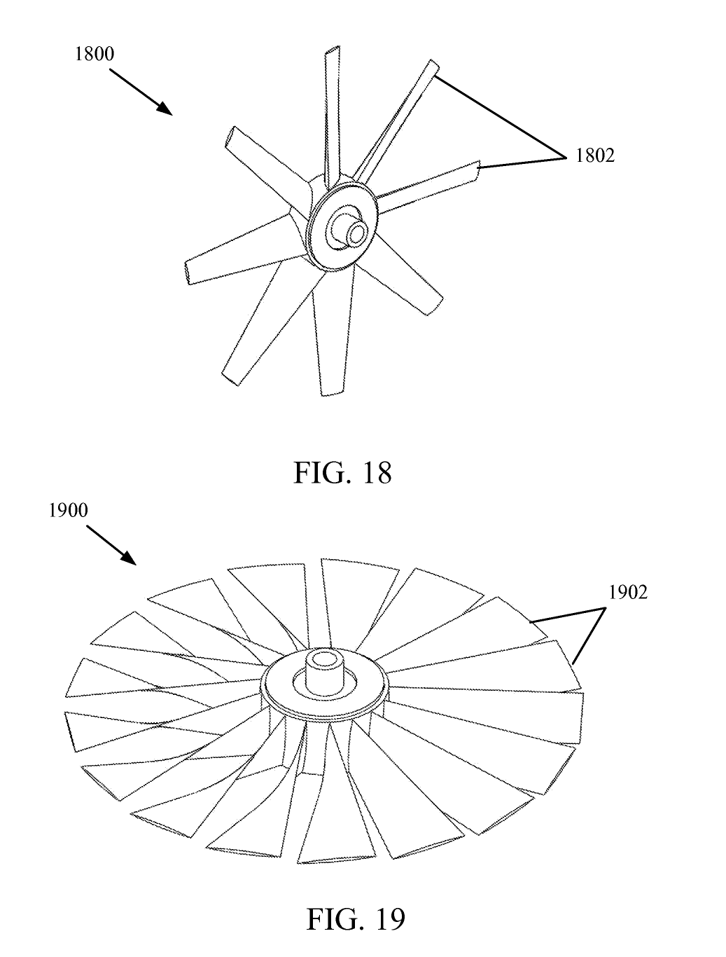

FIG. 18 illustrates one embodiment of a multi-blade impeller 1800 that may be used within any of the turbines featured in the aircraft 100, 500, 700, 800, and 900, modules 1000, and module arrays 1300 to generate electricity. The multi-blade impeller may have a plurality of blades 1802 that may be straight or curved in shape. FIG. 19 illustrates another embodiment of a multi-blade impeller 1900 that features a curved blades 1902 as depicted in FIG. 19. As air flows past the blades 1802 or 1902 of the impellers 1800 and 1900, electricity is generated by the turbines.

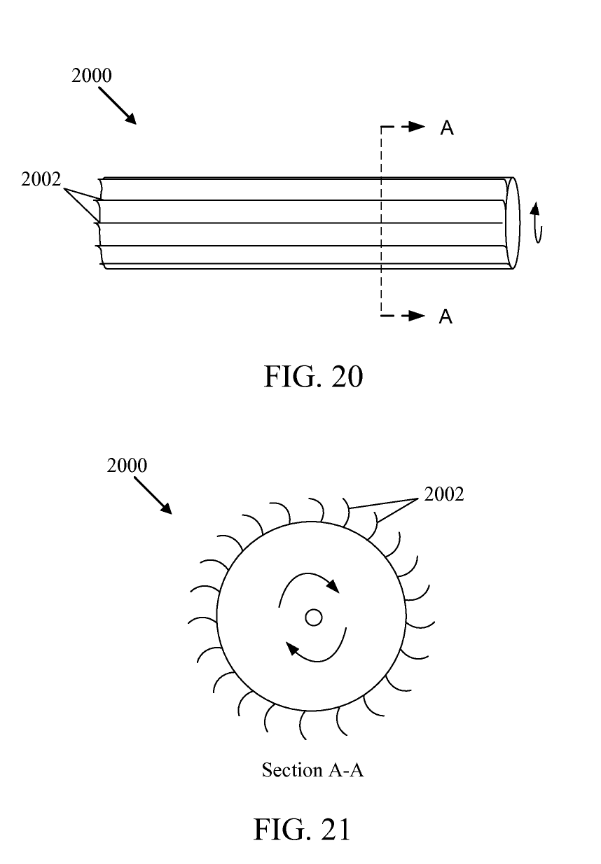

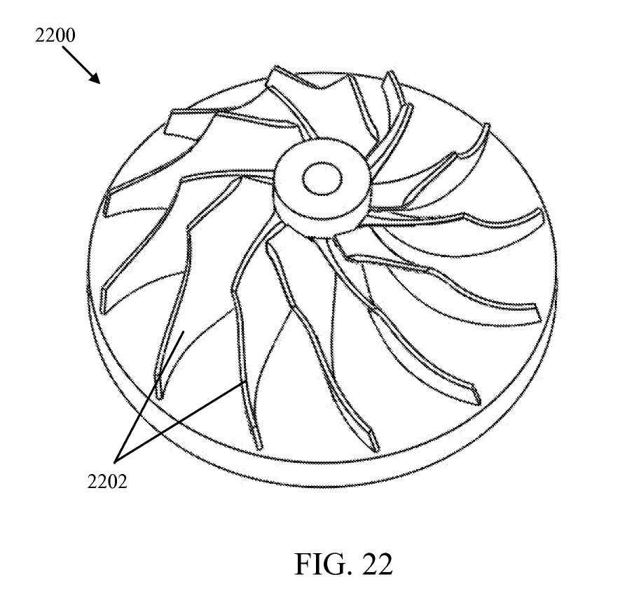

By contrast to the traditional propeller style turbines (as illustrated in FIG. 3), in another embodiment, a turbine 2000 as shown in FIG. 20 utilizing a paddle-wheel design may be implemented in any of the aircraft disclosed herein. FIG. 21 illustrates a cross section of the turbine 2000. The rotational arrows signify the axis of rotation of the turbine 2000. The turbine 2000 may have a plurality of blades 2002 that in one embodiment may extend out straight in a radial direction from the axis of rotation. In another embodiment, the blades 2002 may be curved as shown in the cross-sectional view of FIG. 21. FIG. 22 illustrates yet another embodiment of a turbine 2200 that may be used with the aircraft 100, 500, 700, 800, and 900, modules 1000, and module arrays 1300 to generate electricity. The turbine 2200 has blades 2202 that are curved as shown in FIG. 22.

Other advantages of having such high altitude wind-to-power generators include that there are likely to be fewer bird strikes, they take up less land space (in comparison to windmills), wind speeds at high altitudes are greater and have less turbulence compared to lower altitude winds making the turbines more efficient and able to produce more electricity at a more consistent rate, all of which may allow for lower costs and greater profits.

The method of energy production according to the invention may be particularly useful at remote sites and/or for industries where electrical consumption is high. A large, centrally located factory may manufacture the modules and ship them overseas for minimal assembly, or, the modules may be floated into place from great distances, creating an instant power plant.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A wind-to-power generator aircraft comprising:
a primary body filled with a lighter-than-air gas to provide buoyancy to the aircraft;
a wind funnel coupled along a length of the primary body, a large end of the wind funnel located at a front of the aircraft and a small end of the wind funnel located approximately at a middle of the aircraft, the wind funnel positioned to concentrate airflow from the large end to the small end;
a diffuser coupled along the length of the primary body, a large end of the diffuser located at a rear of the aircraft and a small end of the diffuser located approximately at the middle of the aircraft, the diffuser positioned to disperse airflow from the small end of the diffuser to the large end of the diffuser;
a wind-to-electricity turbine positioned between the wind funnel and the diffuser and configured to convert the airflow passing from the wind funnel to the diffuser into electricity, the turbine having a first end coupled to the small end of the wind funnel and a second end coupled to the small end of the diffuser, wherein the turbine is ducted; and
one or more tethers coupled to the aircraft to secure the aircraft to the ground and transmit electricity from the turbine to a ground station.

2. The aircraft of claim 1, wherein the primary body has a tapered first end and a tapered second end, the primary body comprising light weight materials.

3. The aircraft of claim 1, wherein the wind funnel and the diffuser are coupled along a bottom portion of the primary body.

4. The aircraft of claim 1, wherein the one or more tethers are configured to couple to one or more tether winches at the ground station that adjust the altitude of the aircraft.

5. The aircraft of claim 1, further comprising a plurality of pitch control lines to control the pitch of the aircraft, wherein a first pitch control line is coupled to a first pitch control tie point positioned approximately at the front middle of the aircraft and a second pitch control line is coupled to a second pitch control tie point positioned approximately at the middle underside of the aircraft.

6. A module for generating electricity from airflow, comprising:
one or more primary bodies filled with a lighter-than-air gas to provide buoyancy to the module;
a plurality of wind funnels coupled along a length of a truss, each of the plurality of wind funnels having a large end located at a front of the module and each of the plurality of wind funnels having a small end located approximately at a middle of the module, the plurality of wind funnels positioned to concentrate airflow from the large end to the small end of each of the plurality of wind funnels;
a plurality of diffusers coupled along the length of the truss, each of the plurality of diffusers having a large end located at a rear of the module and each of the plurality of diffusers having a small end located approximately at the middle of the module, the plurality of diffusers positioned to disperse airflow from the small end to the large end of each of the plurality of diffusers;
a plurality of wind-to-electricity turbines, wherein each turbine is positioned between one of the plurality of wind funnels and one of the plurality of diffusers, the turbines being configured to convert the airflow passing from the plurality of wind funnels to the plurality of diffusers into electricity, each of the plurality of turbines having a first end coupled to the small end of each of the plurality of wind funnels and each of the plurality of turbines having a second end coupled to the small end of each of the plurality of diffusers, wherein the turbines are ducted;
wherein the truss is configured to secure the one or more primary bodies, the plurality of diffusers, the plurality of wind funnels, and the plurality of wind-to electricity turbines; and
one or more tethers coupled to the module to secure the module to the ground and transmit electricity from the plurality of turbines to a ground station.

7. The module of claim 6, wherein the truss secures three primary bodies, six wind funnels, six diffusers, and six turbines.

8. The module of claim 6, further comprising a plurality of pitch control lines to control the pitch of the module, wherein a first pitch control line is coupled to a first pitch control tie point positioned approximately at the front middle of the module and a second pitch control line is coupled to a second pitch control tie point positioned approximately at the middle underside of the module.

9. The module of claim 6, wherein the one or more tethers are configured to couple to one or more tether winches at the ground station that adjust the altitude of the aircraft.

10. The module of claim 6, wherein the plurality of wind-to-electricity turbines have a paddle-wheel design.

11. A module array for generating electricity from airflow, comprising:
a plurality of modules interconnected to one another with one or more tethers, wherein each of the plurality of modules comprises
one or more primary bodies filled with a lighter-than-air gas to provide buoyancy to each of the plurality of modules,
a plurality of wind funnels coupled along a length of a truss, each of the plurality of wind funnels having a large end located at a front of the module and each of the plurality of wind funnels having a small end located approximately at a middle of the module, the plurality of wind funnels positioned to concentrate airflow from the large end to the small end of each of the plurality of wind funnels,
a plurality of diffusers coupled along the length of the truss, each of the plurality of diffusers having a large end located at a rear of the module and each of the plurality of diffusers having a small end located approximately at the middle of the module, the plurality of diffusers positioned to disperse airflow from the small end to the large end of each of the plurality of diffusers,
a plurality of wind-to-electricity turbines, wherein each turbine is positioned between one of the plurality of wind funnels and one of the plurality of diffusers, the turbines being configured to convert the airflow passing from the plurality of wind funnels to the plurality of diffusers into electricity, each of the plurality of turbines having a first end coupled to the small end of each of the plurality of wind funnels and each of the plurality of turbines having a second end coupled to the small end of each of the plurality of diffusers, wherein the turbines are ducted,
wherein the truss is configured to secure the one or more primary bodies, the plurality of diffusers, the plurality of wind funnels, and the plurality of wind-to electricity turbines, and
wherein the one or more tethers secure the module array to a ground station and transmit electricity from the plurality of wind-to-electricity turbines of the plurality of modules to the ground station.

12. The module array of claim 11, wherein each truss of the plurality of modules secures three primary bodies, six wind funnels, six diffusers, and six turbines.

13. The module array of claim 11, wherein each of the plurality of modules are spaced sufficiently away from adjacent modules to prevent collateral damage.

14. The module array of claim 11, wherein the one or more tethers are configured to couple to one or more tether winches at the ground station that adjust the altitude of the module array.

15. The module array of claim 11, further comprising a plurality of pitch control lines to control the pitch of the plurality of modules in the module array, wherein a first pitch control line is coupled to a first pitch control tie point positioned approximately at the front middle of each of the plurality of modules and a second pitch control line is coupled to a second pitch control tie point positioned approximately at the middle underside of each of the plurality of modules.

16. The module array of claim 11, wherein the wind-to-electricity turbines of each of the plurality of modules have a paddle-wheel design.
